(19) United States
(12) Patent Application Publication
(10) Pub. No.: US 2017/0364907 A1
(43) Pub. Date: Dec. 21, 2017

(54) METHOD FOR SENDING SECURITY INFORMATION

(71) Applicant: OBERTHUR TECHNOLOGIES, Colombes (FR)

(72) Inventors: Francis CHAMBEROT, Colombes (FR); Pierre VAURES, Colombes (FR)

(21) Appl. No.: 15/627,473

(22) Filed: Jun. 20, 2017

(30) Foreign Application Priority Data
Jun. 20, 2016 (FR) 1655732

(51) Int. Cl. G06Q 20/34; G06Q 20/40

(52) U.S. Cl. CPC G06Q 20/341; G06Q 20/409

(57) ABSTRACT

A method and apparatus for sending security information are disclosed. The method is performed by a terminal that performs operations, which may include: during a current transaction, receiving first transaction data coming from an electronic device with which the terminal is co-operating; detecting an event encountered by the terminal during the current transaction; generating a transaction message including an indicator indicating that the first data is included in a field of the message; inserting security information in the field of the transaction message as a replacement for the first transaction data, the security information being representative of the event; and sending the transaction message including the security information to a remote server.

### BACKGROUND OF THE INVENTION

The present invention lies in the general field of terminals (or readers) configured to co-operate with electronic devices, e.g. such as smart cards, in order to perform a transaction.

The invention relates in particular to such terminals returning useful information to a remote server in order to perform appropriate processing.

The invention applies more particularly, but not exclusively, to terminals (or readers) configured to process a transaction using the Europay Mastercard Visa (EMV) protocol, e.g. with a smart card (or microcircuit card) in compliance with the ISO7816 standard.

In general manner, a smart card is designed to communicate with a device that is external to the card, otherwise known as a terminal or a reader. Such cards serve to perform various types of transaction, such as payment transactions or transactions for authenticating the holder, for example. By way of example, smart cards for bank applications (credit cards, debit cards, etc.) are adapted to communicate with payment terminals.

EMV is the standardized protocol that is the most used throughout the world specifically for making secure payment transactions performed by smart cards in co-operation with an appropriate terminal.

The EMV protocol was designed to reduce the risk of fraud during a payment transaction, in particular by making it possible both to authenticate the smart card and its holder. The authentication process relies on a combination of cryptograms (or encrypted keys) and of digital signatures, and it optionally requires a secret code to be input by the holder of the card, which code is commonly referred to as a personal identification number (PIN).

Depending on the type of card used, on the situation, or indeed on the amount in question, an EMV card may operate on-line or off-line. In on-line mode the EMV card may communicate via the reader with the corresponding issuing entity (e.g. the bank that issued the card) in order to verify that the current transaction is legitimate. In contrast, if the EMV card is used in off-line mode, it applies pre-recorded verification criteria in order to decide whether the transaction is to be authorized or refused.

Numerous security mechanisms have recently been developed in order to make the increasing use of smart cards as secure as possible, in particular cards of the EMV type.

For example, EMV smart cards have been developed that are suitable for detecting attacks of optical or other types that might be made against them by dishonest people or entities. On detecting such an attack, the smart card erases the sensitive data it contains in memory and voluntarily makes itself inoperative. If an EMV dialog is initiated with a reader, the card responds to a RESET message (RS) with an ANSWER TO RESET (ATR) response that is modified indicating that the transaction cannot take place. However little or no information is included in this ATR response, which makes it difficult at the reader end to determine why the dialog has failed.

Furthermore, terminals for co-operating with such smart cards are also liable to be subjected to attacks or to encounter malfunctions or anomalies. At present there does not exist a mechanism enabling security information specific to the terminal to be returned effectively as far as a remote server (e.g. of the card issuer) in order to enable better evaluation and management of security problems or other events encountered by the terminal.

The possibilities of tracking the behaviors of payment terminals, and more generally of the transactions processed by such terminals, are presently limited and require new mechanisms for returning security information from the payment terminal (or reader) to a remote third party such as the issuer of the smart card, for example.

There exists in particular a need for a solution enabling such information to be returned without significantly modifying present communications protocols (e.g. of the EMV type) that are performed by readers for processing a transaction.

### OBJECT AND SUMMARY OF THE INVENTION

To this end, the present invention provides a sending method for sending security information, the method is performed by a terminal and comprises the following steps:
during a current transaction, receiving first transaction data coming from an electronic device with which the terminal is co-operating;
detecting an event encountered by the terminal during the current transaction;
generating a transaction message including an indicator indicating that the first data is included in a field of the message;
inserting security information in the field of the transaction message as a replacement for the first transaction data, the security information being representative of said event; and
sending the transaction message including the security information to a remote server.

In a particular example, the electronic device is a smart card, e.g. of the EMV type.

The invention proposes a mechanism making it possible to return security information specific to the terminal in effective manner to a remote server so as to enable better evaluation and management of events encountered by the terminal.

The security information can thus be processed in appropriate manner by the remote server or by a third party device. On the basis of the security information returned from the terminal, a third party (e.g. the issuer of the smart card) is capable of performing verification checks, and where appropriate, of detecting a fraud or an anomaly encountered by the terminal during one or more transactions.

The invention offers a mechanism that is flexible and effective for returning security information from a bank terminal to a bank server so as to enable the issuer of the smart card (or a third party) to detect any transaction anomalies, malfunctions, or attacks that might be encountered by the bank terminal. It is also possible to analyze risks and/or behavior on the basis of events detected by the bank terminal.

The invention is advantageous in that it is possible to return information from the reader to a remote server without any need to modify the general conduct of a protocol of EMV type, for example. Consequently, implementing the invention does not require significant modification to bank infrastructures.

In a particular embodiment, the detection step includes analyzing transaction data received from the electronic device during the current transaction; and said event is detected from said analyzed transaction data.

In a particular implementation, during the analysis, the terminal uses the transaction data and a transaction history of the terminal to determine whether at least one predefined rule is satisfied; and said event is detected if the predefined rule is satisfied.

In a particular implementation, the received transaction data includes an identifier of the electronic device co-operating with the server; and the transaction history taken into account during the analysis is associated with said electronic device.

In a particular implementation, the transaction history includes the current value of a counter, said analysis including comparing the current value of a counter with a threshold value.

In a particular implementation, the security information comprises the current value of said counter.

In a particular implementation, the event detected by the terminal comprises at least one of the following:
an anomaly in the current transaction;
an anomaly in a sequence of transactions comprising the current transaction and at least one earlier transaction processed by the terminal; and
an attack against the terminal.

In a particular implementation, the first transaction data is data of any one of the following types of transaction data defined by the EMV standard:
CVM list;
application usage check; and
issuer action code.

In a particular implementation, the sending method comprises the following steps:
on detecting said event, determining the security information; and
in a memory of the terminal, storing the security information before said insertion into the transaction message.

In a particular implementation, during the sending step, the transaction message is sent during the current transaction. In a variant, the transaction message is sent after completing the current transaction.

In a particular implementation, the current transaction and the first transaction data comply with the EMV protocol.

In a particular implementation, the various steps of the sending method are determined by computer program instructions.

Consequently, the invention also provides a computer program on a data (or recording) medium, the program being suitable for being performed in a terminal such as a computer, the program including instructions adapted to performing steps of a sending method as defined above.

The invention also provides a recording medium (or data medium) that is readable by a computer and that includes instructions of a computer program as mentioned above.

The invention also provides a processing method performed by a server, said method comprising the following steps:
receiving from a remote terminal a transaction message including an indicator indicating that transaction data in compliance with a first data type is contained in a field of the message;
determining whether the indicator is valid;
if not, detecting that the first data is security information that does not comply with the first data type, said security information being generated by the terminal on detecting an event encountered during a transaction; and
processing the security information in application of at least one predefined rule.

In a particular implementation, the received transaction message contains an identifier of the remote terminal, with the server determining whether the indicator is valid on the basis of the identifier of said remote terminal.

In a particular implementation, the various steps of the processing method are determined by computer program instructions.

Consequently, the invention also provides a computer program on a data medium (or recording medium), the program being suitable for being performed in a server, or more generally in a computer, the program including instructions adapted to perform steps of a processing method as defined above.

The invention also provides a recording medium (or data medium) that is readable by a computer, and including instructions of a computer program as mentioned above.

It should be observed that the computer programs mentioned in the present disclosure may use any programming language and be in the form of source code, object code, or code intermediate between source code and object code, such as in a partially compiled form, or in any other desirable form.

Furthermore, the recording (or data) media mentioned in the present disclosure may be any entity or device capable of storing the program. By way of example, the medium may comprise storage means, such as a read only memory (ROM), e.g. a compact disk (CD) ROM, or a microelectronic circuit ROM, or indeed magnetic recording means, e.g. a floppy disk or a hard disk.

Furthermore, the data medium may comprise a transmissible medium such as an electrical or optical signal suitable for being conveyed via an electrical or optical cable, by radio, or by other means. The program of the invention may in particular be downloaded from an Internet type network.

Alternatively, the data media may correspond to an integrated circuit in which the program is incorporated, the circuit being adapted to execute or to be used in the execution of the method in question.

The invention also provides a terminal comprising:
a receiver module configured to receive, during a current transaction, first transaction data from an electronic device with which said terminal is co-operating;
a detector module configured to detect an event encountered by the terminal during the current transaction;
a generator module configured to generate a transaction message including an indicator indicating that the first transaction data is included in a field of the message, and for inserting security information in the field of the transaction message as a replacement for the first transaction data, which security information is representative of said event; and
a sender module configured to send to a remote server the transaction message including the security information.

The invention also provides a server comprising:
a receiver module configured to receive from a remote terminal a transaction message including an indicator indicating that transaction data in compliance with a first data type is contained in a field of the message;
a determination module configured to determine whether the indicator is valid;
a detector module configured to detect, when the indicator is not valid, that the first data is security information that does not comply with the first data type, said security information being generated by the terminal on detecting an event encountered during a transaction; and
a processor module configured to process the security information in application of at least one predefined rule.

The various implementations and variants defined above with reference to the sending method and the processing method apply in analogous manner to the terminal and to the server of the invention, respectively.

### BRIEF DESCRIPTION OF THE DRAWINGS

Other characteristics and advantages of the present invention appear from the following description given with reference to the accompanying drawings which show embodiments having no limiting character. In the figures:

FIG. 1 is a diagram showing an example of co-operation between a smart card and an external terminal in accordance with the EMV protocol;

FIG. 2 is a diagram showing a system comprising a terminal, a smart card, and remote servers, in a particular embodiment of the invention;

FIG. 3 is a diagram showing the structure of the terminal shown in FIG. 2, in a particular embodiment of the invention;

FIG. 4 is a diagram showing the modules implemented by the FIG. 3 terminal, in a particular embodiment of the invention;

FIG. 5 is a diagram showing the structure of a server shown in FIG. 2, in a particular embodiment of the invention;

FIG. 6 is a diagram of the modules implemented by the FIG. 5 server;

FIG. 7 is a diagram showing a sending method and a processing method in accordance with a particular implementation of the invention;

FIG. 8 is a diagram showing a sending method and a processing method in accordance with a particular implementation of the invention; and

FIG. 9 is a diagram showing a transaction message generated by the terminal shown in FIGS. 2 to 4, in a particular implementation of the invention.

### DETAILED DESCRIPTION OF EMBODIMENTS

As mentioned above, the present invention relates to terminals (or readers) configured to co-operate with electronic devices, e.g. such as smart cards, in order to carry out a transaction. The invention relates in particular to such terminals returning security information to a remote server in order to perform appropriate processing.

In the present disclosure, the present invention is described in the context of a terminal (or reader) co-operating with a smart card by the EMV protocol, the terminal being configured to return security information to a remote server during an EMV transaction or subsequently. Nevertheless, it should be understood that other types of protocol are possible for implementing the invention.

In the present disclosure, the concept of a transaction is to be understood broadly, and by way of example, in the field of banking, it comprises not only a payment or a transfer transaction, but also consulting a bank account on a bank terminal. The invention is described herein in the context of a payment terminal configured to co-operate with a payment card (or bank card) in order to perform payment transactions (or bank transactions). It should be understood that other types of transactions or operations can be envisaged in the context of the invention.

It should also be observed that in the embodiments that follow, the smart card co-operating with the payment terminal is a card in compliance with the ISO7816 standard, it nevertheless being possible for other types of electronic device to process a transaction with a reader. The smart card may communicate with the terminal in contact mode or in contactless mode, depending on the example under consideration.

Unless specified to the contrary, elements that are common or analogous to a plurality of figures are given the same reference numbers and present characteristics that are identical or analogous, such that these common elements are generally not described again, for reasons of simplicity.

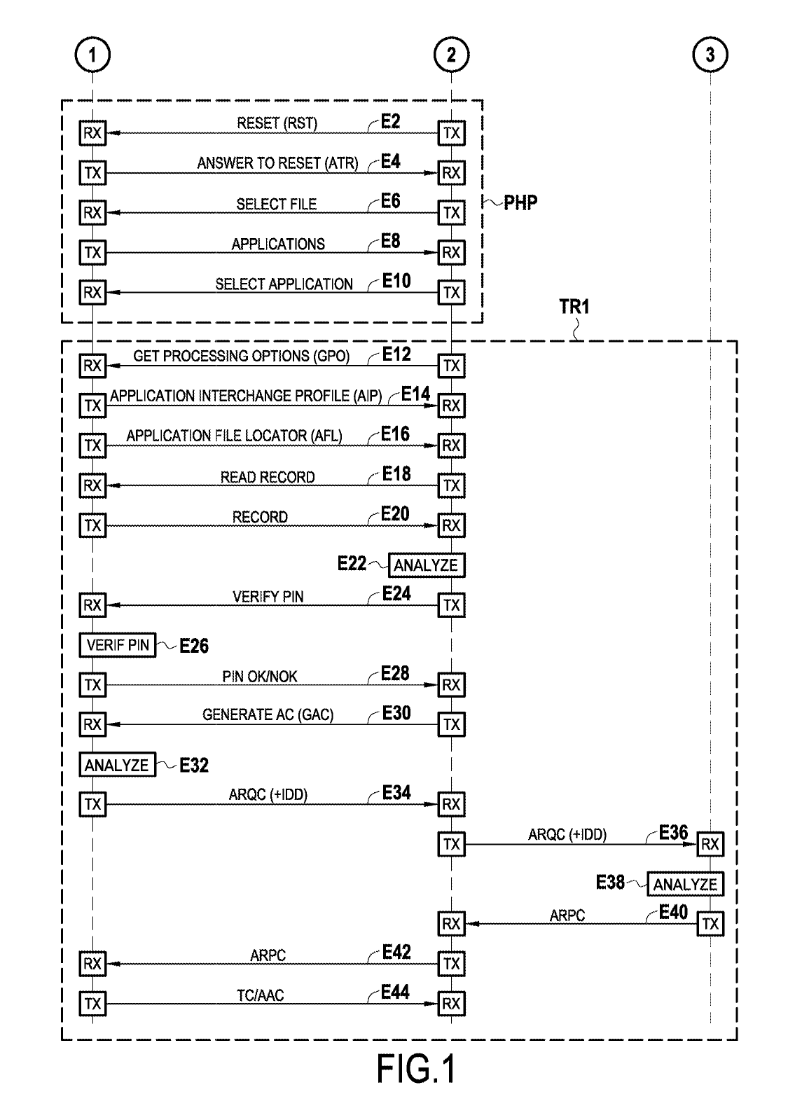

In order to make the invention easier to understand, there follows a description with reference to FIG. 1 of an example of a payment transaction TR1 in compliance with the EMV protocol, this terminal TR1 being performed by a terminal (or reader) 2 in co-operation with an EMV1 smart card 1 and with a bank server 3 associated with the issuer of the card 1. Certain aspects and details of the EMV protocol and various possible variants are omitted in this description for reasons of clarity, the EMV protocol being well known to the person skilled in the art.

In this example, the smart card 1 is a payment card and the reader 2 is a payment terminal.

It is assumed herein that the holder inserts the smart card 1 into the reader 2.

The EMV protocol comprises a preliminary stage PHP for preparing the smart card 1 and the reader 2 to carry out the EMV transaction (written TR1) that is to follow. Various transaction messages in accordance with the EMV protocol are exchanged between the smart card 1 and the reader 2, and (in this example) the bank server 3 during the stage PHP, and subsequently during the transaction TR1.

More precisely, during the preliminary stage PHP, the reader 2 sends (E2) a RESET (RST) message to the payment card 1, which card responds thereto (E4) with an ANSWER TO RESET (ATR) message.

The reader 2 then sends (E6) a SELECT FILE command to the card 1 in order to request the payment card 1 to specify the applications that it is capable of executing. In response, the card 1 supplies (E8) the reader 2 with a list of the various applications that it can implement. The holder can then use the reader 2 to select the desired transaction mode, thereby triggering the sending (E10) of a SELECT APPLICATION command to the card 1.

The reader 2 also sends (E10) a GET PROCESSING OPTIONS (GPO) command to the smart card 1 in order to initiate the start of the transaction TR1. The sending of this GPO command marks the beginning of the EMV transaction.

During this transaction TR1, the payment card 1 sends (E14) information in a first series to the reader 2, in particular informing the reader 2 of the various operations to be undertaken depending on its capabilities for carrying out the transaction TR1. The card 1 also sends (E16) an application file locator (AFL) message listing the data (files and records) that the reader 2 needs to read in the card 1 in order to able to perform the transaction TR1. The reader 2 thus reads (E18-E20) the information specified in the AFL. To do this, the reader 2 sends (E18) one or more READ RECORD commands to the payment card 1 and in return receives (E20) the requested information (referred to as RECORDS).

By way of example, the information read (E18-E20) by the reader 2 in the card 1 comprises the expiry date of the smart card 1, the associated account number, a digital signature (certificate) for authenticating the card 1.

Various implementations can be envisaged. In this example, the reader 2 subsequently performs (E22) an analysis step on the basis of the information supplied (E20) by the payment card 1. If the authentication associated with the payment card 1 fails, if an anomaly is detected, or indeed if too great a risk is detected, the reader 2 can refuse the transaction. It is assumed at this point that the analysis E22 is passed successfully.

The EMV protocol continues in this example with a stage of authenticating the holder of the smart card 1 using an appropriate method. In this example, where the code verification mode is performed, the reader 2 sends (E24) to the payment card 1 a VERIFY request for verifying a PIN code input by the holder. The payment card 1 verifies (E26) whether the PIN code input by the holder is valid.

If the input PIN code is good, the payment card 1 sends (E28) a PIN code acceptance message to the terminal. Otherwise, the card 1 sends (E28) a PIN code error message to the terminal.

Once the holder is authenticated, the EMV protocol continues with a stage of verifying the transaction. More precisely, the reader 2 generates and then sends (E30) a GENERATE AC (GAC) command to the card 1 containing various data items previously requested by the payment card 1 (amount of the transaction, currency used, etc.).

In response to the GAC command, the card 1 performs (E32) an analysis step comprising a certain number of criterion verifications. At the end of the analysis E32, the payment card 1 responds to the reader 2 by sending (E34) a cryptogram (or cryptographic certificate) giving the decision of the card 1. In this example, the smart card 1 sends (E34) an authorization request cryptogram (ARQC) indicating that the card 1 seeks to continue the transaction on-line with the bank server 3 of the card issuer.

The reader 2 thus transmits (E36) the ARQC to the bank server 3 where new analysis is performed (E38) on the basis of the received information. This analysis E38 may comprise various verifications in order to make sure that the transaction TR1 is valid. The reader 2 receives (E40) a response indicating the decision of the issuer together with an ARPC authenticating the decision. The reader 2 transmits (E42) this ARPC message to the payment card 1 in order to inform it of the decision taken by the issuer.

If the card 1 accepts the transaction, it sends (E44) a transaction accepted (TC) type cryptogram in response to the reader 2. Otherwise, the card 1 sends (E44) an AAC type cryptogram indicating that the transaction is refused.

It should be observed that a third party server (not shown) of an acquisition system (or an acquirer) may under certain circumstances act as an interface between the terminal 2 and the bank server 3.

The various above messages exchanged using the EMV protocol during the transaction TR1 between the smart card 1 and the reader 2 and also between the reader 2 and the server 3 constitute examples of transaction messages in accordance with the EMV protocol.

It should be recalled at this point that the conduct of the EMV transaction as described above with reference to FIG. 1 merely constitutes a non-limiting example. Specifically, the EMV protocol makes numerous alternatives available. It is up to integrators to make the necessary choices for adapting the execution of the protocol depending on requirements (method of authenticating the holder, on-line or off-line transaction, etc.).

The invention proposes a mechanism enabling security information specific to the terminal to be returned effectively as far as a remote server (e.g. of the card issuer) in order to make it possible to improve evaluation and management of events encountered by the terminal.

To do this, the invention provides a sending method performed by a terminal and comprising the following steps:
while a transaction (e.g. of the EMV type) is being processed in co-operation with an electronic device (e.g. a smart card), detecting an event;
generating security information representative of the event; and
sending the security information to a remote server, with the security information being sent by way of example in a transaction message generated by the terminal.

This security information may thus be processed appropriately by the remote server, or a third party device. On the basis of the security information returned from the terminal, a third party (e.g. the card issuer) is capable of performing verification checks and, where appropriate, of detecting fraud or an anomaly encountered by the terminal during one or more transactions.

In a particular implementation, the invention proposes diverting the conventional use of certain EMV transaction data items while complying with the constraints imposed by EMV. The EMV standard thus makes provision for certain transaction data items transmitted by the smart card to the terminal to be sent, where appropriate, subsequently by the terminal to a remote server (e.g. the bank server of the issuer), even though such sending is not mandatory. Sending such transaction data to a remote bank server is not always advantageous insofar as the destination (e.g. the card issuer) is sometimes already aware of the transaction data in question. This transaction data is considered as being optional from the point of view of the remote server.

Thus, in a particular implementation, the invention proposes adapting the way in which this transaction data that is optional from the point of view of the remote server is processed by the terminal and by the remote server in question.

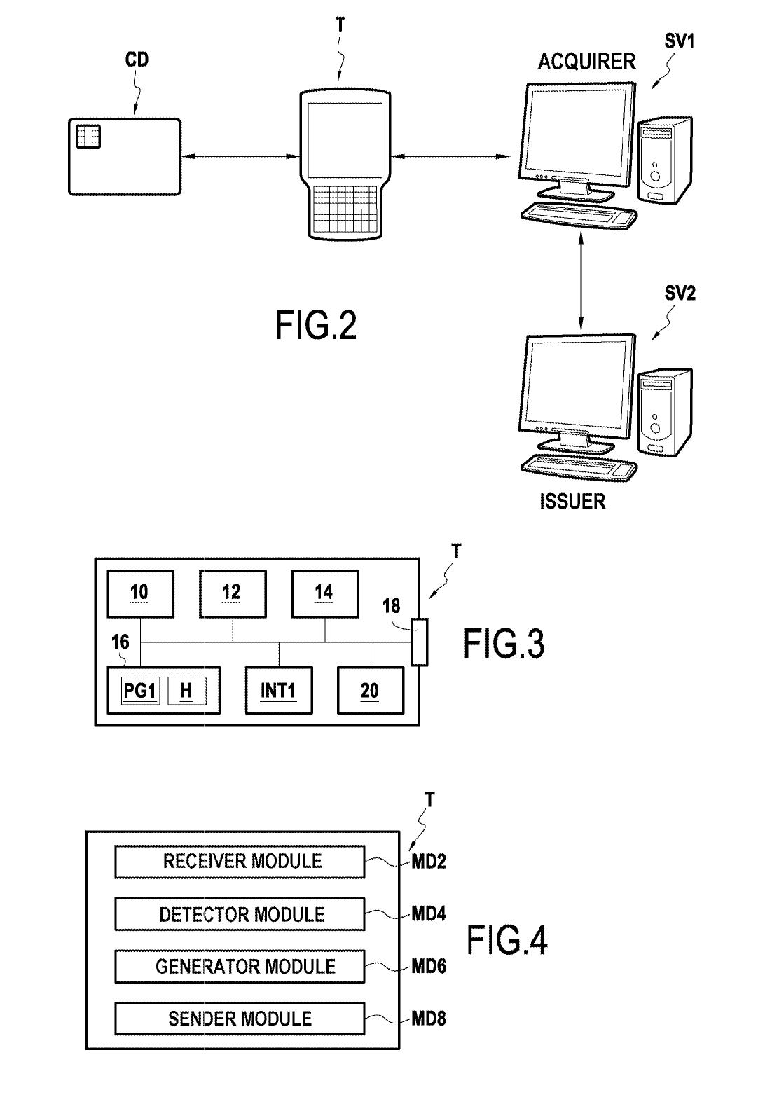

FIG. 2 is a diagram showing a terminal T (or reader) configured to co-operate with a smart card CD and with a remote server SV2 in order to process and EMV transaction in a particular implementation. In this example, a remote server SV1 acts as an interface between the terminal T and the remote server SV2. It is also assumed in this example that the server SV1 is controlled by an acquirer third party (or “acquisition system”), and that the server SV2 is controlled by the issuer of the smart card CD (a bank).

The structure of the terminal T and of the server SV1, and the implementation of the methods of the invention by the terminal T and by the server SV1 are described below in particular examples. It can be understood that certain elements generally present in a terminal (or a reader) and in a server used for processing transaction data have been voluntarily omitted since they are not necessary for understanding the present invention.

It should also be understood that the terminal T and the remote server SV1 shown in FIG. 1 are merely non-limiting embodiments, and other embodiments are possible. The person skilled in the art understands that certain elements of the terminal T and of the remote server SV1 are specifically not described herein in order to make the invention easier to understand and given that these elements are not necessary for performing the invention.

FIG. 3 is a diagram showing the structure of a particular embodiment of the terminal T shown in FIG. 2. More particularly, the terminal T in this example comprises a processor 10 coupled to a rewritable volatile memory 12 (of the RAM type), a man/machine interface 14, a rewritable non-volatile memory 16 (e.g. of the flash type), a first communications interface INT1, a second communications interface 18, and optionally a sensor 20.

The man/machine interface enables a user to interact with the terminal, where necessary. As mentioned above, it is assumed herein that the terminal T is a payment terminal. Alternatively, the terminal T may be an automatic teller machine (ATM), for example.

In this example, the memory 16 constitutes a storage medium in accordance with an embodiment of the invention that is readable by the terminal T and on which there is stored a computer program PG1 in accordance with an embodiment of the invention. The program PG1 includes instructions for executing steps of a method of sending security information IS that may, where appropriate, be stored in the memory 16, in accordance with an embodiment of the invention. Implementations of this sending method are shown in FIGS. 7 to 9 that are described below.

Where appropriate, the memory 16 is also configured to store a transaction history H of the terminal T, this history H comprising transaction data associated with EMV transactions processed in the past by the terminal T. It should be observed that it is possible to perform the invention without making use of such a transaction history H.

The first communication interface INT1 is configured to enable the terminal T to communicate with the remote server SV2 via the remote server SV1.

The second communication interface 18 is configured to enable the terminal T to communicate with the smart card CD, in particular for processing an EMV transaction. In this example, the card 4 is an EMV card in accordance with the ISO7816 standard. Electronic devices other than a smart card (smart phone executing a bank application, etc.) are nevertheless possible for co-operating with the terminal T.

In a particular example, the terminal T also includes at least one sensor 20 configured to detect an attack against the terminal T. By way of example, the sensor may be an optical and/or electromagnetic sensor. By way of example, the sensor serves to detect an optical type attack (e.g. by laser) and/or an electromagnetic type attack (e.g. in order to detect interference in the communications of the terminal T).

The processor 10 controlled by the computer program PG1 in this example implements a certain number of modules shown in FIG. 4, namely: a receiver module M2, a detector module M4, a generator module M6, and a sender module M8.

The receiver module M2 is configured to receive, during an EMV transaction, first transaction data (referenced below as DN1) coming from the smart card CD with which the terminal T is co-operating. Various kinds of first transaction data in the meaning of the invention are possible, as explained below.

The detector module M4 is configured to detect an event EVT encountered by the terminal T during a current EMV transaction. Various types of event in the meaning of the invention are possible, as explained below.

In a particular example, the detector server M4 is configured to detect an event from at least one item of transaction data received by the terminal T during the current EMV transaction. In a variant, the detector module M4 is configured to detect an event from a signal sent by the sensor 20 on detecting an attack for an anomaly encountered by the terminal T.

The generator module M6 is configured to generate a transaction message (referenced MSG1 below) including an indicator MQ indicating the inclusion (or the presence) of the first transaction data received by the receiver module M4 in a data field of said transaction message, and for inserting into this data field, security information (referenced below IS) that takes the place of the first transaction data, which security information is representative of the event EVT detected by the detector module M4.

The sender module M8 is configured to send to the remote server SV1 the transaction message as generated by the generator module M6 and into which the security information IS has been inserted.

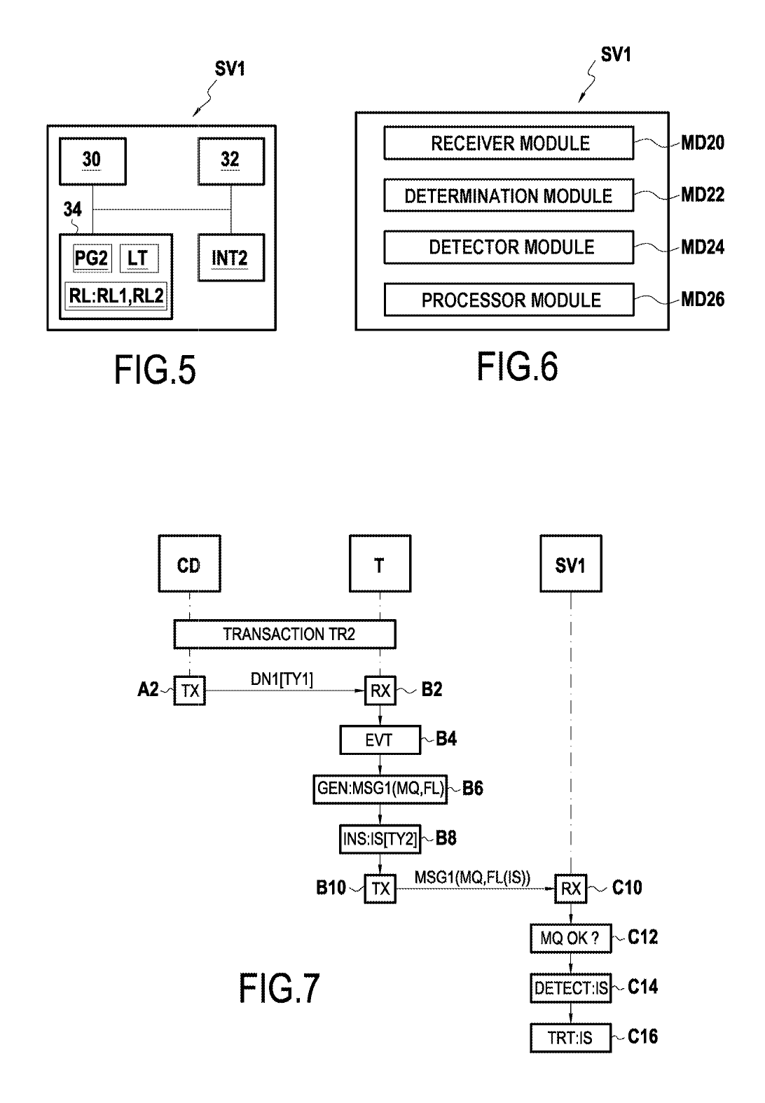

FIG. 5 is a diagram showing the structure of a particular embodiment of the server SV1 shown in FIG. 2. In this example, the server SV1 is configured to co-operate with the terminal T by using the EMV protocol, and if necessary to act as an interface between the terminal T and the server SV2 of the issuer.

More particularly, in this example, the server SV1 comprises a processor 30, a rewritable volatile memory 32 (of the RAM type), a rewritable non-volatile memory 34 (e.g. of the flash type), and a communication interface INT2.

In this example, the memory 36 constitutes a storage medium in accordance with an embodiment of the invention that is readable by the server SV1 and that stores a computer program PG2 in accordance with an embodiment of the invention. The program PG2 includes instructions for executing steps of a processing method in accordance with an implementation of the invention. Implementations of this method are shown below with reference to FIGS. 7 to 9.

In this example, the memory 34 is also configured to store a list LT having at least one identifier of the terminal, together with processing rules RL1 and RL2 (referenced collectively as RL). From the list LT and the processing rules RL1 and RL2, the server SV1 is capable of determining how a transaction message sent by the smart card CD is to be processed. The nature and the function of the list LT and of the rules RL are described in greater detail below. It is also possible to perform the invention without using such a list LT.

The communication interface INT2 enables the server SV1 to communicate with the terminal T (via the interface INT1), and where appropriate also with the issuer's server SV2.

In this example, the processor 30 controlled by the computer program PG2 implements a certain number of modules shown in FIG. 5, namely: a receiver module M20, a determination module M22, a detector module M24, and a processor module M26.

The receiver module M20 is configured to receive from the remote terminal T a transaction message (referenced below MSG1) that includes an indicator MQ indicating that transaction data in accordance with a first data type is contained in a data field of the message.

The determination module M22 is configured to determine whether the indicator MQ is valid.

In the event that the indicator MQ is not valid, the detector module M24 is configured to detect that said first data is security information (IS) that is not in compliance with the first data type, this security information being generated by the terminal T on detecting an event EVT.

The processor module M26 is configured to process the security information (IS) in compliance with at least one predefined processing rule RL.

The principle on which the modules M2-M8 of the terminal T and the modules M20-M26 of the remote server SV1 operate can be seen more clearly from the implementations described below with reference to FIGS. 7 to 9. It can be understood that the modules M2-M26 as shown in FIGS. 4 and 6 merely constitute non-limiting embodiments of the invention.

A particular implementation of the invention is described below with reference to FIG. 7. More precisely, the terminal T performs a sending method by executing the program PG1, and the server SV1 performs a processing method by executing the program PG2, in compliance with a particular implementation of the invention.

It is assumed herein that an EMV terminal, referenced TR2, is being processed by the terminal T in co-operation with the smart card CD.

As mentioned above, it is assumed herein that this is a payment transaction performed using the EMV protocol by the payment terminal T with the help of the smart card CD. More precisely, in this particular example, the smart card CD and the terminal T have together performed the preliminary stage PHP of the transaction TR2 as explained above with reference to FIG. 1.

During the transaction TR2, the smart card CD sends (A2) transaction data DN1 that the terminal T receives during a reception step B2. This transaction data DN1 may for example be transaction data contained in a RECORD read by the terminal T in the smart card CD, as explained above with reference to steps E18 and E20 of FIG. 1.

The transaction data DN1 may be of various types depending on circumstances. In this example, reference TY1 designates the type of the transaction data DN1 received during B2 by the terminal T. In a particular example, the transaction data DN1 complies with one of the following transaction data types as defined in the ENV standard:
a cardholder verification method (CVM) list:
an application usage control (AUC); and
an issuer action code (IAC).

In this example, it is assumed that the transaction data DN1 received in B2 is of the “issuer action code” (IAC) type in accordance with the EMV protocol. In other words: TY1=IAC.

It may be observed that the servers SV1 and SV2 need not necessarily receive data of the IAC type in order to process the transaction TR1 using the EMV protocol. In other words, the IAC data is optional from the point of view of the remote servers SV1 and SV2 insofar as the EMV standard does not require this type of transaction data to be sent to the third party servers SV1 and SV2. By way of example, the bank server SV2 is capable of processing a payment transaction (and of implementing the compensation mechanism between the debited account and the credited account) without receiving any IAC transaction data from the terminal T.

In B4, the terminal T detects an event EVT encountered by the terminal T during the current transaction TR2. In the presently-described example, the detection B4 of the event EVT is performed by the detector module M4 shown in FIG. 4.

The event EVT detected at B4 may for example comprise at least one of the following:
an anomaly in the current transaction TR2;
an anomaly in a sequence of transactions comprising the current transaction TR2 and at least one earlier EMV transaction processed by the terminal T; and
an attack against the terminal.

More generally, the event EVT detected at B4 may be any event encountered by the terminal T and judged by the terminal to be of interest, with this judgment optionally being made on the basis of at least rule defining at least one predefined condition to be satisfied in order for a given event EVT to be detected.

The event EVT as detected in this way by the terminal T may correspond to one or more events.

The detection of the event EVT may result from an interaction with the card CD during the current transaction TR2. The terminal T may for example detect the event EVT on the basis of at least one item of transaction data (optionally including the data DN1) received from the card CD during the transaction TR2. Alternatively, the event EVT may be a physical attack (e.g. of optical and/or electromagnetic type) against the terminal T. Under such circumstances, the attack is thus not detected via the communication interface 18, but rather by the sensor 20 of the terminal T, as explained above.

It may be observed that the event EVT may alternatively be detected prior to the transaction data DN1 coming from the smart card CD being received in B2.

Furthermore, in B6, the terminal T generates a transaction message MSG1 for sending to the remote server SV1. This transaction message MSG1 includes an indicator (or marker) MQ indicating that the first transaction data DN1 (or at least one item of transaction data of type TY1=IAC) is included in a corresponding data field FL of the message MSG1. By way of example, this indicator MQ may be a parameter (or tag) contained in the message MSG1 in order to specify the presence of transaction data of type TY1=IAC in the associated data field FL.

In this example, the message MSG1 may include various types of transaction data needed by the server SV1 and/or the server SV2 for processing the current transaction TR2. By way of example, this transaction message MSG1 may be a frame (or structure) in compliance with the ISO8583 standard.

In a particular example, the transaction message MSG1 is an on-line authorization request of the ARQC type in compliance with the EMV standard, as explained above with reference to the step E34 in FIG. 1.

The terminal T also obtains security information IS representative of the event EVT detected in B4. In this example, the terminal T selects (or generates) security information IS as a function of the event EVT detected in B4. To do this, the terminal T may for example apply a predefined rule specifying information IS that is to be generated for at least one given event EVT (or event type).

During an insertion step B8, the terminal T inserts the security information IS representative of the event EVT into the data field FL of the transaction message MSG1. Although the indicator MQ in the message MSG1 indicates the presence of the transaction data DN1 of type TY1=IAC in the field FL of the message MSG1, it is in fact security information IS that is contained in the field FL, taking the place of the transaction data DN1. In other words, the security information IS is inserted in B8 into the transaction message MSG1 as a replacement for the transaction data DN1 received in B2.

In this example, it is assumed that the security information IS is in compliance with a second data type TY2 that is different from the type TY1 of the transaction data DN1 received in B2. In other words, in the presently-considered example, the security information IS is not IAC transaction data.

As explained below, the insertion B8 advantageously makes it possible for the terminal T to send security information IS to the server SV1 that does not comply with the type TY1 of the transaction data DN1, and to do so while continuing to comply with the EMV protocol.

It should be observed that the generator step B6 and the insertion step B8 may be executed in a single step of generating the transaction message MSG1.

In a particular example, on detecting the event EVT, the terminal T determines the security information IS corresponding to the event EVT, and then stores this security information IS, e.g. in the non-volatile memory 16, in order to insert it subsequently in the transaction message MSG1 during the insertion step B8.

Thereafter, the terminal T sends (B10) the transaction message MSG1 to the remote server SV1 in compliance with the EMV protocol. The server SV1 receives the message MSG1 in C10.

As mentioned above, the indicator MQ included in the transaction message MSG1 indicates the presence in the transaction message MSG1 of transaction data (i.e. DN1 in this example) that is in compliance with the type TY1 equal to IAC, in this example. More precisely, the indicator MQ indicates in this example the presence of IAC transaction data in the data field FL that is associated with the indicator MQ.

During a determination step C12, the server SV1 determines whether the indicator MQ present in the message MSG1 is valid. By way of example, this determination step is performed on the basis of data other than the indicator MQ present in the message MSG1 and received by the server SV1 in C10. In the presently-envisaged example, it is assumed that, on the basis of an identifier of the terminal T included in the message MSG1 received in C10, the server SV1 determines (C12) that the indicator MQ is not valid.

If it is determined in C12 that the marker MQ is not valid, the terminal T deduces (in C14) therefrom that the data contained in the data field FL of the transaction message MSG1 received in C10 is not transaction data of type TY1 (i.e. IAC in this example), in spite of what is indicated by the marker MQ. In this example, if it is determined in C12 that the marker MQ is not valid, the server SV1 recognizes that the data IS contained in the data field FL is security information IS that does not comply with the data type TY1. The server SV1 then processes (C16) the security information IS in appropriate manner, e.g. in compliance with at least one predefined rule defining how security information generated by the terminal T is to be processed. This processing C16 may for example comprise using the security information IS to analyze risk or to check security in order to determine whether the terminal T has encountered an anomaly, an attack, or a malfunction during the transaction TR2.

In the presently-envisaged example, the server SV1 thus does not receive transaction data of the IAC type in C10. Nevertheless, as mentioned above, although the sending of this type of data is possible in the EMV protocol, it is not essential that the servers SV1 and SV2 receive IAC transaction data in order to process the EMV transaction.

The invention advantageously makes it possible to divert the use initially intended by the EMV protocol for a determined type of transaction data in order to transmit security information from the terminal to a remote server.

More particularly, the invention makes it possible, where necessary, for the terminal T shown in FIGS. 2 and 3 to return security information IS to the server SV1 while complying with the EMV standard.

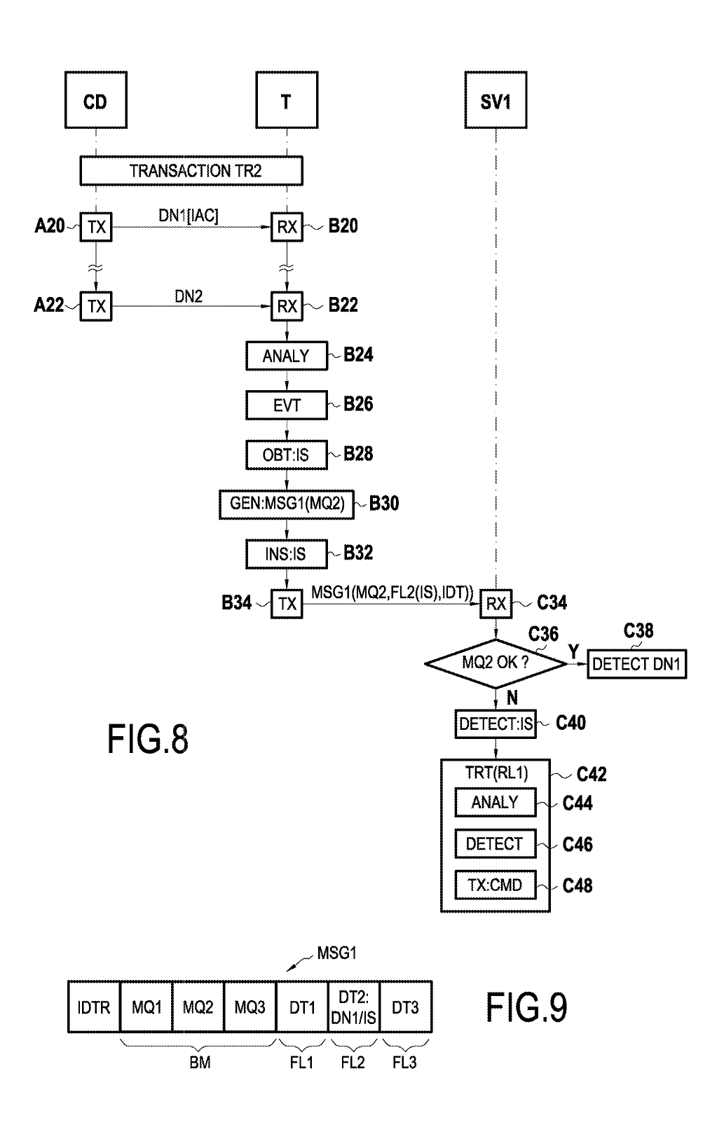

A particular implementation of the methods shown in FIG. 7 is described below with reference to FIGS. 8 and 9. More precisely, the terminal T performs a sending method by executing the program PG1 and the server SV1 performs a processing method by executing the program PG2, in accordance with a particular implementation of the invention.

Once more, it is assumed that the terminal T co-operates with the smart card CD in order to process the current transaction TR2. As mentioned above with reference to FIG. 7, the transaction TR2 is a payment transaction performed using the EMV protocol by the payment terminal T in association with the smart card CD. It is assumed that the smart card CD and the terminal T have together performed the preliminary stage PHP of the transaction TR2 and also the steps E12, E14, and E16 as explained above with reference to FIG. 1.

In A20, the card CD sends first transaction data DN1 (as RECORDS) in response to a read request (not shown) previously sent by the terminal T in the same manner as in the steps E18-E20 described above with reference to FIG. 1. Once more, it is assumed in this example that the transaction data DN1 is IAC data in compliance with the EMV standard. In a variant, the data DN1 may be a CVM list or AUC data, in compliance with the EMV standard. The terminal T receives (B20) the transaction data DN1 as described above with reference to step B2 shown in FIG. 7.

In A22, the card CD also sends at least one second item of transaction data DN2 (likewise as RECORDS) in response to another read command (not shown) previously sent by the terminal T. The terminal T receives the transaction data DN2 in B22. In a variant, the second transaction data DN2 is received (B22) before the first transaction data DN1 is received (B20).

In B24, the terminal T analyses the transaction data DN2 received in A22 from the smart card CD.

In B26, the terminal detects an event EVT from the transaction data DN2 analyzed in B24. By way of example, the detection B26 is performed in analogous manner to step B4 shown in FIG. 7.

In a particular example, during the analysis B24, the terminal T uses the transaction data DN2 and the transaction history H of the terminal T to determine whether at least one predefined rule is satisfied. To do this, the terminal T analyzes the transaction data included in the history H stored locally in the memory 16 of the terminal T, with the event EVT being detected in B26 only if a predefined rule is satisfied. In this way, it is possible for the terminal T to detect anomalies occurring during a sequence of EMV transactions processed by the terminal T, this sequence including the current transaction TR2 together with at least one earlier EMV transaction.

In a particular example, the transaction data DN2 received in B22 includes an identifier of the smart card CD. Furthermore, it is assumed in this example that the transaction history H taken into account by the terminal T is associated with the smart card CD. In other words, the history H stored locally in the memory 16 contains transaction data relating to at least one EMV transaction previously processed by the terminal T in co-operation with the same smart card CD. In the same manner, it is possible for the terminal T to detect anomalies that occur during a sequence of EMV transactions processed by the terminal T with the same smart card CD. By way of example, the terminal T may detect an abnormally high number of EMV transactions performed using the same card CD in a very short time interval.

In a particular example, the transaction history H taken into account by the terminal T during the analysis B24 includes the current value of a counter (not shown) stored in the terminal T. The counter may represent various variables characterizing one or more transactions. The analysis B24 includes comparing the current value of the counter with a predefined threshold value. In a particular example, an event EVT is detected in B26 if the current value of the counter stored in the terminal T exceeds the predetermined threshold value.

Furthermore, the terminal T generates (B28) security information IS representative of the event EVT as mentioned above with reference to the step B6 shown in FIG. 7. The security information IS may be any parameter that can be interpreted by the remote server SV1 in order to indicate the occurrence of an anomaly in a transaction, a particular behavior of the holder of the smart card CD, a malfunction of the terminal T, or a malfunction of the smart card CD, etc. In a particular example, the security information IS includes the current value of a counter as described above with reference to steps B24-B26.

The terminal T then generates (B30) a transaction message MSG1 and inserts (B32) therein the security information IS as described above with reference to steps B6 and B8 (FIG. 7). In this example, the transaction message MSG1 is an on-line authorization request of the ARQC type in compliance with the EMV standard, as mentioned above with reference to step E34 of FIG. 1. In analogous manner in FIG. 7, the generation (B30) and the insertion (B32) may be performed in a single processing step.

FIG. 9 is a diagram of the frame of the transaction message MSG1 generated by the terminal T in B30-B32, in the presently-considered example. More particularly, the message MSG1 comprises an identifier IDTR of the frame (specifically indicating that it is an ARQC authorization request), indicators MQ1 to MQ3, and also data fields FL1 to FL3 (referenced collectively as FL) associated respectively with the indicators MQ1 to MQ3. Each indicator (or marker) MQ1-MQ3 identifies the type of the respective transaction data DT1-DT3 that is contained in the corresponding data field FL1-FL3. In this example, the markers MQ1-MQ3 are contained in a “BITMAP” field BM. By way of example, each indicator MQ1-MQ3 is coded using one or more bits.

In this example, the frame of the transaction message MSG1 complies with the ISO8583 standard.

In this example, it is assumed that the data field FL2 is identified by the indicator MQ2 as containing transaction data DT2 of the IAC type. By way of example, the field FL2 may be adapted to contain the transaction data DN1 of IAC type. Nevertheless, it is assumed that the terminal T, on detecting the event EVT, has decided to insert (B32) the security information IS as obtained in B28 as a replacement for the transaction data DN1 (i.e. occupying its position).

In this example, the transaction message MSG1 generated by the terminal T also includes an identifier IDT of the terminal T.

Thereafter, the terminal T sends (B24) the transaction message MSG1 to the server SV1 which receives it in C34. In this example, the server SV1 is configured to transmit the message MSG1 corresponding to an on-line authorization request of the ARQC type to the remote server SV1.

In C36, the server SV1 determines whether the indicator MQ2 is valid, as described above with reference to step C12 shown in FIG. 7. More particularly, in this example, the server SV1 compares its list LT that contains at least one terminal identifier with the identifier IDT contained in the transaction message MSG1 received in C34. On the basis of the result of this comparison, the server SV1 determines whether the indicator MQ2 is valid, in other words whether the data DT2 contained in the data field FL2 is indeed of the IAC type, as indicated by the indicator MQ2. If so (MQ2 is valid), then the method continues with C38. Otherwise, the method continues with C40.

In C38, the server SV1 processes the data DT2 present in the data field FL2 of the message MSG2 as IAC transaction data, as indicated by the marker MQ2. Under such circumstances, the server SV1 processes the data DT2 using the processing rule RL2 stored in its memory.

In C40, the server SV1 detects that the data DT2 is security information IS that is not in compliance with the IAC type, as described above with reference to step C14 shown in FIG. 7. The server SV1 then processes (C42) the security information IS as explained above with reference to step C14 shown in FIG. 7. In this example, the server SV1 processes in C42 the security information IS using the processing rule RL1 stored in its memory, this rule RL1 being different from the rule RL2.

In this example, the processing step C42 comprises at least one of the following:
using the security information IS to analyze (C44) risk associated with the current transaction TR2;
detecting a fraud or an anomaly associated with the current transaction TR2 or associated with the current transaction TR2 and at least one earlier EMV transaction; and
sending a predefined command to the terminal T for the card CD.

It should be observed that in the above-described implementations, the transaction message MSG1 is sent (B10, B34) during the current EMV transaction. By way of example, this transaction message corresponds to an on-line authorization request of the ARCQ type in compliance with EMV. Nevertheless, other types of transaction message can be envisaged for conveying the security information to a remote server. In a variant, the security information is transmitted by the terminal after completing the current EMV transaction.

The invention provides a mechanism that is flexible and effective for returning security information from a bank terminal to a bank server so as to enable the smart card issuer (or some other third party) to detect possible anomalies in transactions, malfunctions or attacks that might be encountered by the bank terminal. It is also possible to perform analyses of risks and/or investigations concerning the behavior of the holder of the bank card on the basis of events detected by the bank terminal.

The invention is advantageous in that it makes it possible to return information from the reader to a remote server (e.g. the bank card issuer) without any need to modify the general conduct of a protocol of the EMV type, for example. Consequently, the invention can be performed without significant modification of bank infrastructures.

A person skilled in the art will understand that the above-described implementations and variants are merely non-limiting examples of how the invention can be performed. In particular, the person skilled in the art can envisage any combination of the variants and implementations described above in order to satisfy any particular need.

1. A method for sending security information, which method is performed by a terminal, the method comprising:
during a current transaction, receiving first transaction data coming from an electronic device with which the terminal is co-operating;
detecting an event encountered by the terminal during the current transaction;
generating a transaction message including an indicator indicating that the first transaction data is included in a field of the transaction message;
inserting security information in the field of the transaction message as a replacement for the first transaction data, the security information being representative of said event; and
sending the transaction message including the security information to a remote server.

2. The method according to claim 1, wherein the detecting includes analyzing second transaction data received from the electronic device during the current transaction; and
detecting said event from said second transaction data that was analyzed.

3. The method according to claim 2, wherein, during the analyzing, the terminal uses the second transaction data and a transaction history of the terminal to determine whether at least one predefined rule is satisfied; and
wherein the detecting comprises detecting said event if the at least one predefined rule is satisfied.

4. The method according to claim 3, wherein the received second transaction data includes an identifier of the electronic device co-operating with the remote server; and
the transaction history is associated with said electronic device.

5. The method according to claim 3, wherein the transaction history includes the current value of a counter, and wherein the analyzing includes comparing the current value of the counter with a threshold value.

6. The method according to claim 5, wherein the security information comprises the current value of said counter.

7. The method according to claim 1,
wherein the event detected by the terminal comprises at least one of:
an anomaly in the current transaction;
an anomaly in a sequence of transactions comprising the current transaction and at least one earlier transaction processed by the terminal; and
an attack against the terminal.

8. The method according to claim 1, wherein the first transaction data includes any one of the following types of transaction data defined by the Europay Mastercard Visa (EMV) standard:
cardholder verification method (CVM) list;
application usage check; and
issuer action code.

9. The method according to claim 1, including the following steps:
on detecting said event, determining the security information; and
in a memory of the terminal, storing the security information before said inserting into the transaction message.

10. The method according to claim 1, wherein, during the sending, the transaction message is sent during the current transaction.

11. The method according to claim 1, wherein the current transaction and the first transaction data comply with the Europay Mastercard Visa (EMV) protocol.

12. A processing method performed by a server, said method comprising:
receiving from a remote terminal a transaction message including an indicator indicating that transaction data in compliance with a first data type is contained in a field of the transaction message;
determining whether the indicator is valid;
if not, detecting that the transaction data is security information that does not comply with the first data type, said security information being generated by the remote terminal on detecting an event encountered during a transaction; and
processing the security information by application of at least one predefined rule.

13. The method according to claim 12, wherein the received transaction message contains an identifier of the remote terminal, and wherein the determining includes determining whether the indicator is valid on the basis of the identifier of said remote terminal.

14. A non-transitory computer-readable medium including instructions that, when executed by a computer of a terminal, cause the computer to perform operations comprising:
during a current transaction, receiving first transaction data from an electronic device with which the terminal is co-operating;
detecting an event encountered by the terminal during the current transaction;
generating a transaction message including an indicator indicating that the first transaction data is included in a field of the transaction message;
inserting security information in the field of the transaction message as a replacement for the first transaction data, the security information being representative of the event; and
sending the transaction message including the security information to a remote server.

15. A terminal comprising:
a receiver module configured to receive, during a current transaction, first transaction data from an electronic device with which said terminal is co-operating;
a detector module configured to detect an event encountered by the terminal during the current transaction;
a generator module configured to generate a transaction message including an indicator indicating that the first transaction data is included in a field of the transaction message, and configured to insert security information in the field of the transaction message as a replacement for the first transaction data, which security information is representative of said event; and
a sender module configured to send to a remote server the transaction message including the security information.

16. A server comprising:
a receiver module configured to receive, from a remote terminal, a transaction message including an indicator indicating that transaction data in compliance with a first data type is contained in a field of the transaction message;
a determination module configured to determine whether the indicator is valid;
a detector module configured to detect, when the indicator is not valid, that the transaction data is security information that does not comply with the first data type, said security information being generated by the remote terminal on detecting an event encountered during a transaction; and
a processor module configured to process the security information by application of at least one predefined rule.
